(19) United States
(12) Patent Application Publication
(10) Pub. No.: US 2017/0004465 A1
(43) Pub. Date: Jan. 5, 2017

(54) METHODS AND SYSTEMS FOR FOR IMPLEMENTING VIRTUAL INTERNATIONAL BANKING

(71) Applicant: The Western Union Company, Englewood, CO (US)

(72) Inventor: Girish Balasubramanian, Fremont, CA (US)

(73) Assignee: THE WESTERN UNION COMPANY, Englewood, CO (US)

(21) Appl. No.: 14/788,155

(22) Filed: Jun. 30, 2015

(51) Int. Cl. G06Q 20/10; G06Q 20/02

(52) U.S. Cl. CPC G06Q 20/108; G06Q 20/023

(57) ABSTRACT

Systems and methods for conducting a money transfer include providing a virtual banking account for the money transfer and determining standing instructions corresponding to the virtual banking account. The standing instructions may include a protocol-based workflow for conducting the money transfer. The systems and methods may further include identifying a trigger corresponding to a movement of monetary funds from an originating account to the virtual banking account, and after identifying the trigger, initiating a transfer of at least a portion of the monetary funds from the virtual banking account to a destination account based on the standing instructions.

### BACKGROUND OF THE INVENTION

Money transfer facilitators and other financial institutions that provide financial products and services may offer international money transfers. Such cross-border movements of money are increasingly prevalent among their customers, which may include individual consumers and/or businesses. However, such transactions are often complicated, time-consuming, and costly for the customers. For instance, wiring fees for transferring money internationally are typically expensive and customers may need to follow complicated or unfamiliar procedures each time such transfers are made. There is a need for improved infrastructure that facilitates money transfers, such as cross-border money transfers. This application is intended to address such needs and to provide related advantages.

### BRIEF SUMMARY OF THE INVENTION

This invention generally relates to systems and methods for conducting money transfers, and more specifically, to systems and methods for conducting money transfers utilizing a virtual banking account.

In one aspect, the present disclosure provides a method for conducting a money transfer. The method may include one or more steps of providing, by a computer system, a virtual banking account for conducting the money transfer and/or determining, by the computer system, standing instructions corresponding to the virtual banking account. The standing instructions may include a protocol-based workflow for the computer system to conduct the money transfer. The method may further include identifying, by the computer system, a trigger corresponding to a movement of monetary funds from an originating account to the virtual banking account. The method may include, after identifying the trigger, initiating, by the computer system, a transfer of at least a portion of the monetary funds from the virtual banking account to a destination account based on the standing instructions.

Various embodiments of the method may include one or more of the following features. The virtual banking account may correspond to the originating account of a sender of the money transfer. The virtual banking account may correspond to the destination account of a receiver of the money transfer. The method may include creating, by the computer system, the virtual banking account based on transaction information received at the computer system during a one-time initial set-up. The method may include creating, by the computer system, the standing instructions based at least in part on the transaction information received at the computer system during the one-time initial set-up, associating, by the computer system, the standing instructions with the virtual banking account, and/or storing, by the computer system, the standing instructions and the virtual banking account. Further, the method may include determining, by the computer system, the trigger based on at least one of the transaction information and the standing instructions, and/or detecting for, by the computer system, the trigger corresponding to the virtual banking account. The trigger may include a detection of an increase in a balance of the virtual banking account. Additional and/or alternatively, the trigger may include a detection of a movement of the monetary funds from the originating account to the virtual banking account.

Other embodiments of the method may be contemplated to include one or more of the following features. The standing instructions may include an ACH transaction number for the destination account. The method may include automatically transferring, by the computer system, the monetary funds from the virtual banking account to the destination account upon identifying the trigger. The protocol-based workflow may include a schedule for transferring the monetary funds to the destination account, whereby the schedule indicates the portion of the monetary funds to be transferred to the destination account and a predetermined timeline for transferring the portion to the destination account. The method may include transferring, by the computer system, a plurality of portions of monetary funds to a plurality of destination accounts. The method may include notifying, by the computer system, at least one of the originating account and the destination account that the monetary funds are at the virtual banking account. Still, the method may include requesting, by the computer system, a confirmation from at least one of the originating account and the destination account to transfer the portion of the monetary funds from the virtual banking account to the destination account prior to completing the transfer.

Further embodiments of the method may be contemplated. The protocol-based workflow may include requesting the confirmation upon determining, by the computer system, that the monetary funds exceeds a predetermined threshold amount. The method may include receiving, by the computer system, a modification to the standing instructions, modifying, by the computer system, the standing instructions prior to completing the transfer, and completing, by the computer system, the transfer based on the modified standing instructions. Additionally and/or alternatively, the method may include adjusting, by the computer system, the portion of the monetary funds based at least in part on a foreign exchange rate, and/or transferring, by the computer system, the adjusted portion to the destination account. The method may include determining, by the computer system, that a holding period of time in which the monetary funds occupy the virtual banking account exceeds a maximum holding period, and/or notifying, by the computer system, at least one of the originating account and the destination account that the monetary funds must be transferred out of the virtual banking account based on the determination. Other features and embodiments are possible.

In another aspect of the present disclosure, a system for conducting a money transfer is provided. The system may include one or more processors and a memory communicatively coupled with and readable by the one or more processors. The memory may have stored therein processor-readable instructions that, when executed by the one or more processors, cause the one or more processors to conduct the money transfer. For instance, the processor-readable instructions may cause the one or more processors to provide, by a computer system, a virtual banking account for conducting the money transfer monitor, and/or determine, by the computer system, standing instructions corresponding to the virtual banking account. The standing instructions may include a protocol-based workflow for the computer system to conduct the money transfer. Further, the processor-readable instructions may cause the one or more processors to identify, by the computer system, a trigger corresponding to a movement of monetary funds from an originating account to the virtual banking account, and after identifying the trigger, initiate, by the computer system, a transfer of at least a portion of the monetary funds from the virtual banking account to a destination account based on the standing instructions.

In yet another aspect of the present disclosure, a computer-readable medium has stored thereon a series of instructions which, when executed by a processor, cause the processor to conduct a money transfer. The series of instructions may include providing, by a computer system, a virtual banking account for conducting the money transfer, determining, by the computer system, standing instructions corresponding to the virtual banking account, whereby the standing instructions comprise a protocol-based workflow for the computer system to conduct the money transfer, and/or identifying, by the computer system, a trigger corresponding to a movement of monetary funds from an originating account to the virtual banking account. Further, the series of instructions may include, after identifying the trigger, initiating, by the computer system, a transfer of at least a portion of the monetary funds from the virtual banking account to a destination account based on the standing instructions.

### BRIEF DESCRIPTION OF THE DRAWINGS

The present invention is described in conjunction with the appended figures:

FIG. 1 shows an example method for conducting a money transfer according to various embodiments of the present invention;

FIG. 2 shows an example system for conducting a money transfer according to various embodiments of the present invention;

FIG. 3 shows another example method for conducting a money transfer according to various embodiments of the present invention;

FIG. 4 shows yet another example method for conducting a money transfer according to various embodiments of the present invention; and

FIG. 5 shows an example computer architecture upon which various aspects of the present invention may be implemented.

In the appended figures, similar components and/or features may have the same numerical reference label. Further, various components of the same type may be distinguished by following the reference label by a letter that distinguishes among the similar components and/or features. If only the first numerical reference label is used in the specification, the description is applicable to any one of the similar components and/or features having the same first numerical reference label irrespective of the letter suffix.

### DETAILED DESCRIPTION OF THE INVENTION

In the following description, for the purposes of explanation, numerous specific details are set forth in order to provide a thorough understanding of various embodiments of the present invention. It will be apparent, however, to one skilled in the art that embodiments of the present invention may be practiced without some of these specific details. In other instances, well-known structures and devices are shown in block diagram form.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the invention as set forth in the appended claims. Thus, with regard to any specific embodiment discussed herein, any particular detail or aspect thereof may or may not be present in each contemplated version of that embodiment. Likewise, any particular detail or aspect of one embodiment discussed herein may or may not be present in any possible version of other embodiments discussed herein.

Further, specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

The term “machine-readable medium” includes, but is not limited to, portable or fixed storage devices, optical storage devices, wireless channels and various other mediums capable of storing, containing or carrying instruction(s) and/or data. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

In general, the systems and methods described herein provide for money transfers utilizing an intermediary, virtual bank account that serves to automate or otherwise streamline a desired funds transaction for a user. For example, the user, who may be an individual and/or business entity, may hold a main bank account that is affiliated and/or otherwise provided for by a money transfer facilitator (“MTF”), bank, or other financial institution. According to the present invention, the provider may further offer the user one or more virtual banking accounts associated with the user's main account. Each virtual banking account may facilitate the user in sending and/or receiving monetary funds according to a set of predetermined standing instructions that are applicable to a certain predefined money transfer circumstance. Each particular set of standing instructions and circumstances may be defined by the user during a one-time initial setup and/or subsequently updated as needed by the user. Various examples and embodiments are described below.

In practice, the systems and methods disclosed herein may facilitate funds transfers by providing a convenient, efficient, and cost-effective approach to transferring money. The present invention may provide simple, automated and/or streamlined options for the user to transfer money internationally. Merely by way of example, a user located in example country A and having a main bank account with a bank account provider may establish, via the provider, a virtual banking account that is located in example country B, which is different than country A. For instance, the provider may have international branches and the virtual banking account may be associated with a foreign branch of the provider's international network. The user's virtual banking account may serve to provide a local presence in country B for the user who is located in country A. Using the virtual banking account, the user may deposit monetary funds from the user's own local account into the user's virtual banking account. The virtual banking account may forward the user's deposited funds to a receiver's bank account, which is a foreign bank account provided by a foreign bank that is located in country B.

In the foregoing example, the wiring fees may be reduced for the user since the virtual banking account is within the user's own account and/or provider. The provider may transmit the money from its foreign branch to the foreign bank of the recipient, which may not be regarded as a cross-border transaction and therefore incur less or no fees for the user. Further, international transactions may be simplified as the user simply transfers the money from its main account into the virtual banking account, or deposits a check directly into the virtual banking account. The virtual banking account may be set up to automatically handle the remaining “cross-border” steps of the transaction to move the deposited funds into the receiver's bank account. In some aspects, the user's provider may offer the lower or improved fees for such transactions by having a high volume of international transactions among its client base. Numerous other variations and examples are possible, as discussed herein below. It is noted that cross-border money transfers may be discussed, but local and regional money transfers may be implemented and improved upon using the systems and methods as well.

It is further noted that in practice, the invention allows both a sender and a receiver of an international money transfer to operate in their respective banking ecosystems by making the global transaction appear local via a local presence, which is provided for by the virtual banking account. The present systems and methods reduce and/or eliminate the customer's perceived and/or actual costs associated with foreign transactions, which may promote usage frequencies and enhance user experiences with international money transfers. Further, the systems and methods may eliminate a need for a merchant to set up entities, such as local entities in foreign countries, in order to make trades in such countries. Reducing the number of entities may eliminate or reduce taxes, tax filings, and so on. In another aspect, the systems and methods permit collection of funds with local currency. For instance, the provider having the systems and methods may issue the user the virtual banking account number whereby any money deposited therein is converted with up-to-date foreign exchange rates based on a destination account for the transaction. In a further aspect, know-your-customer (“KYC”) and anti-money-laundering (“AML”) compliances, and other procedures or checks, may be streamlined and/or automated by the systems and methods herein. Other benefits and examples are possible.

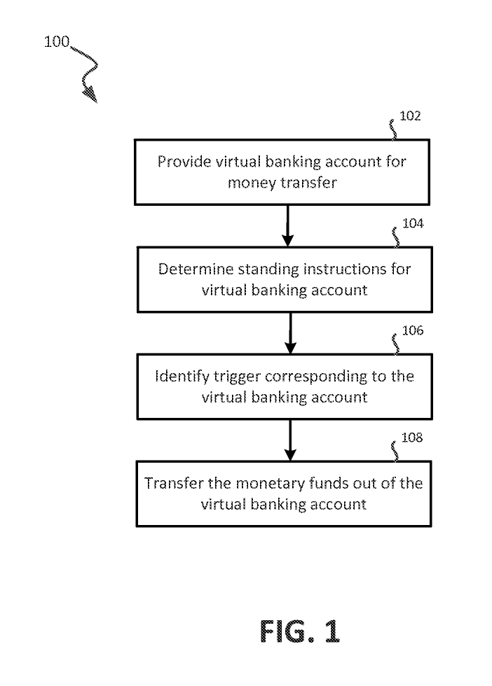

Turning to FIG. 1, an example method 100 for conducting money transfers utilizing a virtual banking account is shown. The method 100 may be performed by a host system, such as a computer system, of a money transfer facilitator or provider. It is noted that method 100, and any of the other methods shown herein, may include additional steps, and that any of the method steps may be reordered, combined with other steps from other methods, and/or optional. Further, it is noted that the virtual banking account may be referred to interchangeably as a mailbox account, forwarding account, intermediary account, and/or virtual bank account throughout the present disclosure.

As shown in FIG. 1, the method 100 may include providing a virtual banking account for a desired and/or initiated money transfer (step 102). For instance, a user holding an existing account with a provider may have a designated primary bank account for sending and/or receiving money. The provider may offer one or more virtual banking accounts for the user's existing account, which may be regarded as one or more secondary accounts. At step 102, providing the virtual banking account may include creating or otherwise setting up a new virtual banking account for a particular transaction and/or type of transaction for the user under the user's existing account at the provider. In another example, at step 102, providing the virtual banking account may including locating an existing virtual banking account that has already been established in the computer system for the user's existing account, such as one that is established earlier during a one-time initial setup. Locating the correct virtual banking account may include identifying certain parameters of the money transfer and matching the parameters with predetermined details or instructions associated with the virtual banking account. Such details may include a sender and/or receiver's identity, a foreign country involved, and/or an originating and/or destination account for the transfer. Other examples are possible In other aspect, the virtual banking account may be single-use or have a limited number of usages before expiring, or have an operational period with a termination date upon which the virtual banking account becomes inactive. In yet another example, the virtual banking account may expire if a fee, such as a membership, monthly, and/or yearly fee for the account is not paid for in time or missed by the user. Other examples are possible.

It is noted that the virtual banking account may be provided under the user's existing account in numerous ways. The virtual banking account may be configured to transmit funds to/from a particular country having numerous customers, a particular customer, a particular receiver, a particular sender, and/or numerous receivers and senders. For example, a virtual banking account may be utilized by a business entity having a primary account at the provider and one virtual banking account per country that it operates in. Each virtual banking account may be set up separately and/or concurrently. Other examples are possible. The virtual banking account may be unidirectional for monetary flow. For instance, the virtual banking account may be configured to transfer funds out of the user's existing account to an outside party's destination account, or may be configured to transfer funds into the user's existing account from an outside party's originating account. In other examples, the virtual banking account may be bidirectional and allow for incoming and outgoing money transfers into the virtual banking account, and subsequently into and out of the user's existing account.

In some cases, the virtual banking account corresponds to the originating account of a sender of the money transfer. For instance, the virtual banking account is established by the originating account provider. In other cases, the virtual banking account corresponds to the destination account of a receiver of the money transfer. For instance, the virtual banking account is established by the destination account provider. In another aspect, the virtual banking account may be created by the computer system based on transaction information from the user, which may be received at the computer system during a one-time initial set-up and/or during subsequent updates, modifications, and so on. Such transaction information may include, merely by way of example, a bank account and/or routing number for a destination of the money transfer, a recipient name, a sender name, a country name, a money transfer tracking or control number (“MTCN”), a transaction date, associated fees, currency type, a schedule for transferring the money to various different destination accounts, and so on. Various examples are possible.

As further shown in FIG. 1, the method 100 may include determining standing instructions for the virtual banking account (step 104). In one example, the standing instructions include a protocol-based workflow for the computer system to conduct the money transfer. The method 100 may include creating the standing instructions based at least in part on the transaction information received at the computer system during the one-time initial set-up or later on. Such standing instructions may be associated, by the computer system, with the identified or created virtual banking account, whereby the standing instructions may be stored with the virtual banking account.

In one example, the standing instructions include an automated clearing house (“ACH”) transaction number for the transaction. In other examples, the standing instructions include one or more destination account numbers in which any monetary funds at the virtual banking account are intended to be transferred to. The standing instructions may include automatically transferring, by the computer system, the monetary funds from the virtual banking account to the destination account. In some cases, the funds may be automatically transferred upon identification of a trigger, as described further below. In another example, the protocol-based workflow includes a schedule for transferring the monetary funds to the destination account. The schedule may indicate a partial or whole portion of the monetary funds to be transferred to the destination account. The schedule may indicate a predetermined timeline for transferring the portion(s) to the destination account. In further examples, a plurality of portions of monetary funds are transferred to a plurality of destination accounts per the standing instructions.

Still further shown in FIG. 1, the method 100 may include identifying a trigger that corresponds to the virtual banking account (step 106). In some examples, the trigger corresponds to a movement of monetary funds from an originating account to the virtual banking account. The method may include determining the type of trigger based on at least one of the transaction information and the standing instructions, and detecting for the particular trigger that corresponds to the virtual banking account. In another example, the trigger includes a detection of an increase in a balance of the virtual banking account. In another example, the trigger includes a detection of a movement of the monetary funds from an originating account to the virtual banking account. Merely by way of example, monetary funds may be direct deposited by a user's employee into the virtual banking account, which may activate the trigger and/or cause the money to be automatically transferred from the virtual banking account to a predetermined destination account.

In other aspects, the method 100 may include notifying at least one of the originating account and the destination account that the monetary funds are at the virtual banking account. Such notifications may be sent to a sending and/or receiving party of the money transfer via email, text message, mail, social notifications, voicemail, and/or any other type of communication. The method 100 may include requesting a confirmation from a user of at least one of the originating account and the destination account to transfer the portion of the monetary funds from the virtual banking account to the destination account. In some cases, the monetary funds may remain in the virtual banking account until such confirmation is received, and subsequently complete the transfer. In some cases, the protocol-based workflow requests the confirmation upon determining that the monetary funds exceed a predetermined threshold amount. The predetermined threshold amount may be any amount that is defined by the provider, and/or by the user of the virtual banking account. In yet another example, the method 100 may include receiving a modification to the standing instructions and modifying the standing instructions prior to completing the transfer. Merely by way of example, the user may receive a notification of funds received at the virtual banking account and decide to route the funds to another account other than the predetermined destination account. In that case, the user may call or electronically (via online account or web access) update the standing instructions. Such modifications may apply to the particular money transfer and/or be implemented for all subsequent transfers at the virtual banking account. The method 100 may further include adjusting the portion of the monetary funds based at least in part on a foreign exchange rate and transferring the adjusted portion to the destination account. A plurality of different foreign exchange rates may be applied depending on locations of a plurality of destination accounts.

Referring again to FIG. 1, the method 100 may include transferring the monetary funds out of the virtual banking account (step 108). For example, after identifying the trigger, the method 100 may initiate a transfer of at least a portion of the monetary funds from the virtual banking account to a destination account based on the standing instructions. In some cases, the method 100 may include determining that a holding period of time in which the monetary funds occupy the virtual banking account exceeds a maximum holding period. In that case, the method may include notifying at least one of the originating account and the destination account, or a user or owner of the virtual banking account, that the monetary funds must be transferred out of the virtual banking account. The maximum holding period may be determined by the provider and/or based on taxes or charges related to an amount of time, or money, that monetary funds occupy the virtual banking account. Other examples are possible.

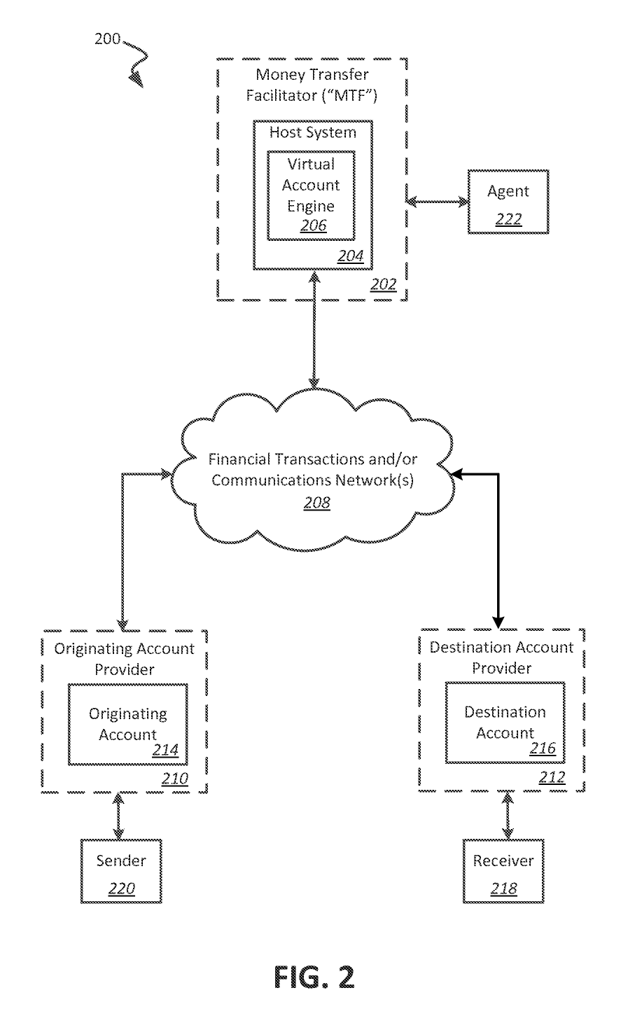

Turning now to FIG. 2, a schematic diagram of an example system 200 for making money transfers according to various methods and embodiments herein is shown. It is noted that variations are possible, and that some connections and/or entities may be omitted merely for simplicity in the diagram. The system 200 may include a money transfer provider system or money transfer facilitator (“MTF”) 202, e.g. systems operated by Western Union or another money transfer provider service. The MTF 202 may include a host system 204, such as a host computer system that provides a virtual account engine 206, among other hardware and software components. It is contemplated that the virtual account engine 206 may provide or otherwise assist the host system 204 in providing the money transactions described herein, such as in method 100. For instance, the virtual account engine 206 may provide and operate the virtual banking account(s).

The MTF 202, and/or more specifically the host system 204, may be communicatively coupled with various network(s) 208, such as financial transactions networks and/or communications networks. Also communicatively coupled with one or more of the network(s) 208 may be one or more account providers 210 and 212, which may maintain, control, or otherwise manipulate originating and destination accounts 214 and 216, respectively. The originating account 214 may be any of a variety of accounts, such as a traditional bank account, in which case originating account provider 210 may be a financial institution. According to other embodiments, the originating account 214 may be a virtual (or e-money) wallet, in which case the originating account provider 210 may be a mobile operator or agent. Similarly, the destination account 216 may be any of a variety of accounts, such as a bank or virtual (e-money) account, and the destination account provider 212 may be a financial institution, mobile operator, or agent accordingly. While not shown in FIG. 2 for purposes of clarity, in some cases where the virtual banking account is associated with the originating account 214, the originating account provider 210 and the MTF 202 may be the same entity. In other cases where the virtual banking account is associated with the destination account 216, the destination account provider 212 and the MTF 202 may be the same entity. Further, it is contemplated that the originating account provider 210 and the destination account provider 212 may be cross-border or foreign providers to one another.

Additionally, as explained in embodiments detailed herein, a recipient or receiver 218 of a money transfer may also receive money in cash at a regular agent location 222. Such agents may comprise an individual, group, retail location, or other entity that allows customers to access services of the MTF 202. In other cases, a sender 220 may also initiate a money transfer in cash at the regular agent location 222 if the agent location 222 is local to the sender 220. Still in other examples, money transfers may be initiated remotely and/or via the internet, such as online banking accounts, telephone, and so on. Generally speaking and as understood by one skilled in the art, the money transfer provider 202 may access the originating account 214 of one account provider 210 and/or the destination account 216 of the same or a different account provider 212 to affect a transfer from and/or to the accounts 214 and 216 via the financial transfer network 208.

The money transfer provider system 200 may also be adapted to identify the entities and/or accounts associated with a transaction and/or determine a destination for a payment of the transaction. For example, the entities and/or accounts may be identified based on data maintained in a verification database or other repository, and/or standing instructions associated with various virtual banking accounts. Such data may be maintained internally or externally to the money transfer provider system 200. In one example, the verification database may be maintained by a host system 204 of the MTF 202. Other examples and communications pathways are possible.

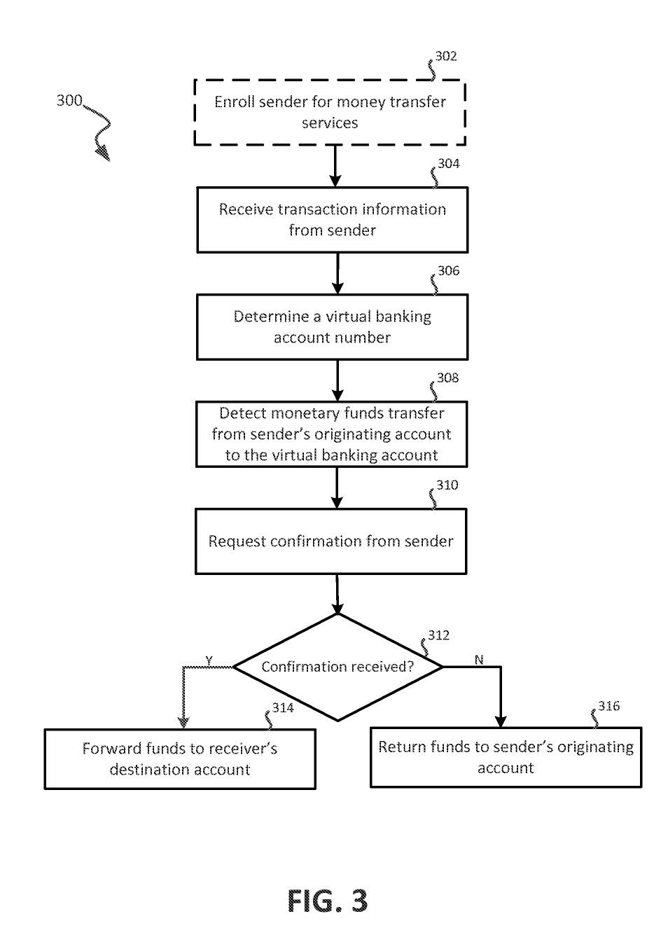

Turning to FIG. 3, another example method 300 for virtual international banking is shown. The method 300 may be provided by the virtual account engine 206 of the host system 204. It is noted that method 300, and any of the other methods shown herein, may include additional steps, and that any of the method steps may be reordered, combined with other steps from other methods, and/or optional.

As shown in FIG. 3, the method 300 may include enrolling a sender of the money transfer for money transfer services provided by the MTF (step 302). It is noted that step 302 is optional and the sender may not need to be enrolled with the MTF providing the virtual banking services. In another aspect, step 302 may be included in a one-time setup procedure whereby subsequent money transfers by the sender, and/or for particular money transfers between the sender and a particular receiving party, may utilize previously established enrollments and/or previous information received, such as transaction information. In other examples, the method 300 may include receiving transaction information from the sender (step 304).

The method 300 may include determining a virtual banking account number (step 306) and/or detecting that monetary funds have been transferred from the sender's originating account to the virtual banking account (step 308). In some cases, the provider may establish a virtual bank account for each receiver that the sender specifies. Merely by way of example, if the sender is in Germany, the provider may provide the sender with a German bank account number for each of the sender's receivers, whereby the German bank account number may be, or otherwise correspond to, the virtual bank account that is owned by the provider. In that case, the virtual bank account number may follow a numbering system that corresponds to a foreign jurisdiction.

Along with determining the virtual bank account number at step 306, the method may include determining, or otherwise specifying standing instructions. Such instructions may include a specified pickup procedure for the money. For instance, the sender may note if the receiver will collected the transferred money in cash from the provider, and/or if the transferred funds will be picked up from the receiver's own bank, which may be a foreign bank having her foreign bank account. The receiver's bank account number may be included in the standing instructions. In another aspect, the standing instructions may cause the computer system, such as a processor of the computer system, to watch or otherwise detect for incoming funds at the virtual bank account. A trigger may be activated indicating the sender has transferred money into the virtual banking account, whereby the computer system may lookup and/or obtain the standing instructions associated with the virtual banking account and execute the money transfer.

The method 300 may include requesting confirmation from the sender that the monetary funds in the virtual banking account should be moved to a particular receiver's account per currently established standing instructions and/or a transfer schedule (step 310). It is noted that modifications may be made. For instance, the sender may alter a recipient's destination account, alter an amount, transfer the monetary funds or a portion thereof back out of the virtual banking account into the sender's originating account, change the transfer schedule, and so forth.

It is noted that confirmation at step 312 may be optional, as any of the other steps, and/or only triggered under special circumstances. For instance, once the monetary funds arrive in the virtual banking account, they may be nearly immediately and automatically forwarded to the receiver's destination account (step 314) per the standing instructions, thereby bypassing the confirmation requirement at step 312. In other aspects, the standing instructions, or other protocols in place, may require confirmation at step 312 upon detecting that the monetary funds in the virtual banking account exceed a threshold amount. Such threshold amounts may be determined by the provider and/or the sender. In another aspect, as soon as the virtual banking account is credited, the method 300 may include contacting the sender to confirm fee information, foreign exchange rates, and/or otherwise ensure that the virtual banking account only accepts transfers from the sender's own bank, as opposed to third parties attempting to send money via the virtual bank account.

In some examples, the confirmation is received from the sender and/or a plurality of different parties. In other examples, the confirmation includes one or more standing instructions and/or workflows. For instance, once monetary funds are received at the virtual banking account, an accounts receivables authority may be notified, but if the monetary funds exceed a certain amount, a higher level authority may be notified to confirm the procedure. It is contemplated that various notifications, rules, permissions, and/or actions may be stipulated by the standing instructions and/or the confirmation. In further examples, the provider may forward the monetary funds from the virtual banking account immediately per the standing instructions. In other examples, the monetary funds in the virtual banking account are not immediately forwarded. If the monetary funds are held in the virtual banking account for a predetermined period of time, such as any number of days, the method 300 may include assessing taxes and/or providing further reminders that the money and/or confirmation is outstanding.

In an aspect, it is contemplated that the virtual banking account allows for flexibility and/or currency hedging. For instance, the user of the virtual banking account, and/or the host system, may forecast that a foreign exchange rate is going upward in the near future. The user may hold the monetary funds in the virtual banking account until the foreign exchange rate is more favorable and then transfer it into user's primary account. In a further aspect, the monetary funds may be moved per the standing instructions, or otherwise, at certain times of the days, or at the end of a week. For example, if the virtual banking account is shared by a plurality of sending parties into one receiving party, the user may select to automatically transfer any funds in the virtual banking account to the user's primary account at the end of each day. In some cases, the method 300 may confirm with the user if funds were moved correctly and/or arrived at the primary account. In other cases, the method 300 may generate and/or send receipts to a sending and/or receiving party. For instance, the host system may generate a receipt for the money transfer, whereby the receipt lists information related to the money transfer such as a date, time, originating account identifier, destination account identifier, a foreign exchange rate, and/or a transaction fee. Further, the host system may calculate a cut of the monetary funds transferred into and/or out of the virtual banking account and make some fraction of the funds as a fee or charge. In another example, such fees may be flat monthly fees and/or flat per-transaction fees.

In another example, the method 300 may include rejecting the transfer and returning the monetary funds to the sender's originating account (step 316). For example, if a certain period of time has passed where confirmation was not received, the money transfer may be rejected. In other examples, if confirmation were denied or otherwise rejected by the sender, and/or if fraud and/or other KYC/AML issues are detected by the computer system, the money transfer may be rejected. The virtual banking account, sender's originating account, receiver's destination account, and/or the particular money transaction attempt may be flagged for further investigation by the computer system. In further examples, if a statutory period of time has passed in which the monetary funds occupy the virtual banking account, the system may return the money to the sender's bank account, and/or further ensure that the monetary funds have been returned to the correct account.

In the above method 300, it is contemplated that whenever the sender wishes to transfer money to a receiver, the sender may merely perform a bank transfer from the sender's originating account to the virtual banking account that is already established. The transfer may be immediate, and/or per the standing instructions be delayed. The sender may establish multiple, unlimited virtual banking accounts, although various fees and charges may apply. In practice, the sender need not enter transaction details every time he/she wishes to send to a particular receiver. In some cases, the sender may not need to perform additional logins to conduct the money transfer. The sender may simply login to the provider's online banking website, transfer money into the virtual banking account, and that transferred money may be automatically pushed out to the designated receiver account. Merely by way of example, the sender may transmit money to a family member's bank account on a weekly basis, or per biweekly paycheck, easily without needing to remember to transfer the money every time.

It is further noted that in some examples, the virtual banking account may be converted to a primary and/or actual bank account. For instance, the system may receive further information from the customer, such as customer KYC and/or identity, and utilize such information to convert the virtual bank account to a checking and/or saving bank account number. Merely by way of example, if a business entity utilizing the virtual banking account were to open a sales office, the provider may offer an option to convert their virtual banking account to a checking and/or savings account, which may offer more privileges. Such privileges may include paying out, withdrawing money, writing checks, paying bills, and the like. Such accounts may still retain standing instructions, and/or other types of standing instructions.

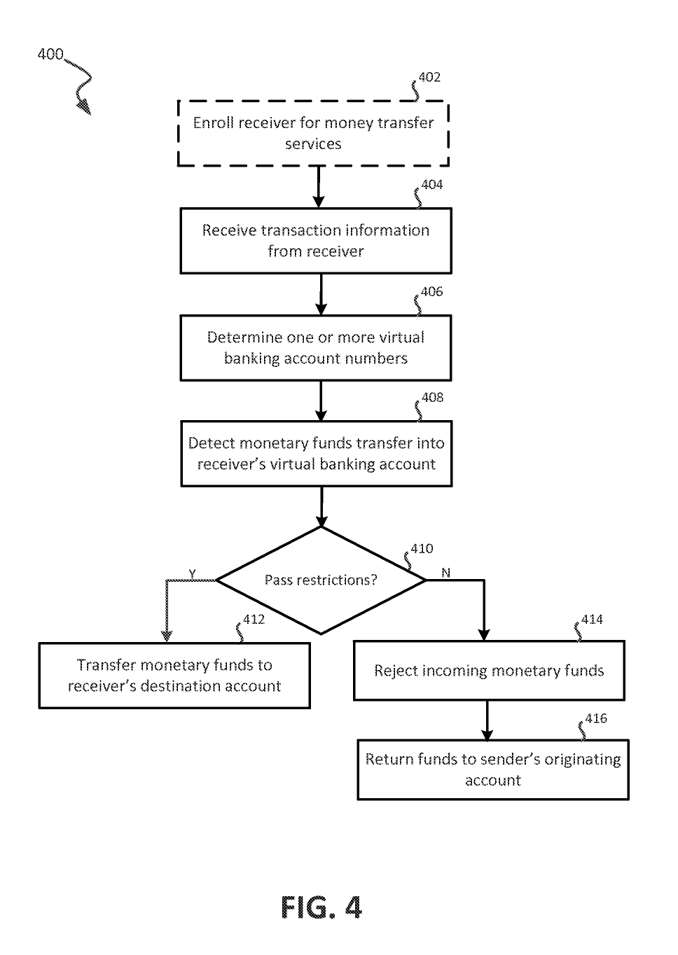

Turning now to FIG. 4, another example method 400 for conducting money transfers utilizing virtual banking accounts is shown. The method 400 may be provided by the virtual account engine 206 of the host system 204. It is noted that method 400, and any of the other methods shown herein, may include additional steps, and that any of the method steps may be reordered, combined with other steps from other methods, and/or optional.

The method 400 may include enrolling a receiver or recipient of the money transfer for money transfer services provided by the MTF (step 402). For example, a receiver such as a merchant may set up a virtual banking account per country, so that customers of those merchants, such as the senders, may send the money from local banks into the virtual banking system. In another aspect, the merchant may set up a virtual banking account per customer per country, whereby the virtual banking account is uniquely latched or tied to a particular sender or deal. The method 400 may further include steps to facilitate such transactions in compliance with local and/or international regulations.

It is noted that step 402 is optional and the receiver may not need to be enrolled with the MTF providing the virtual banking services. In another aspect, step 402 may be included as a one-time setup procedure whereby subsequent money transfers with the receiver, and/or for particular money transfers between the receiver and a particular sending party, may utilize previously established enrollments and/or other information received, such as transaction information. In other examples, the method 400 may include receiving transaction information from the receiver (step 404). The method 400 may include determining, and/or creating, one or more virtual banking account numbers (step 406).

The method 400 may include detecting that monetary funds have been transferred into the receiver's virtual banking account (step 408). In an aspect, upon detecting that a sender (customer) transferred money into the virtual banking account, the receiver (merchant) may reject the funds and return them to the sender's bank account. In other cases, as soon as the funds have been transferred into the virtual banking account, the method 400 may include sending the funds to the merchant's account in the merchant's local and/or preferred currency per standing instructions associated with the virtual banking account.

The method 400 may include determining if any restrictions are associated with the virtual banking account and if the current money transfer is in compliance with such restrictions (step 410). For instance, example restrictions may include only allowing specific sending parties or specific originating accounts to transfer the monetary funds into the virtual banking account. It is noted that modifications may be made, for instance, the receiver may alter their destination account, alter an amount to be transferred at this time or a later date from the virtual banking account, transfer the monetary funds or a portion thereof back out of the virtual banking account into the sender's originating account, change the transfer schedule, and so on.

If the money transfer is in compliance with the restrictions at step 410 and/or if no restrictions are placed, the method 400 may include transferring the monetary funds into the receiver's destination account (step 412). In some cases, this step is automatic upon detection that the monetary funds have arrived in the virtual banking account (step 408) and/or restrictions are passable (step 410).

In other examples, the money transfer may not pass restrictions at step 410. For instance, the money may have arrived at the virtual banking account from a non-approved or otherwise unwanted sender's originating account. Such stipulations and restrictions may be provided for in the transaction information received at step 404 and/or in the standing instructions related to the particular virtual banking account. In this case, the method 400 may include rejecting the incoming monetary funds (step 414) and/or returning the monetary funds back to the sender's originating account (step 416).

In yet another example, the virtual banking account may act as a biller account number that enables any funds transferred therein to be forwarded as payment toward a recurring bill. Merely by example, a sender may have a primary account and set up a virtual banking account having a plurality of receivers, and/or one virtual banking account per receiver. The receiver may be indicated by a biller tag, such as a billing company's name and/or bill date. Still, other examples are possible.

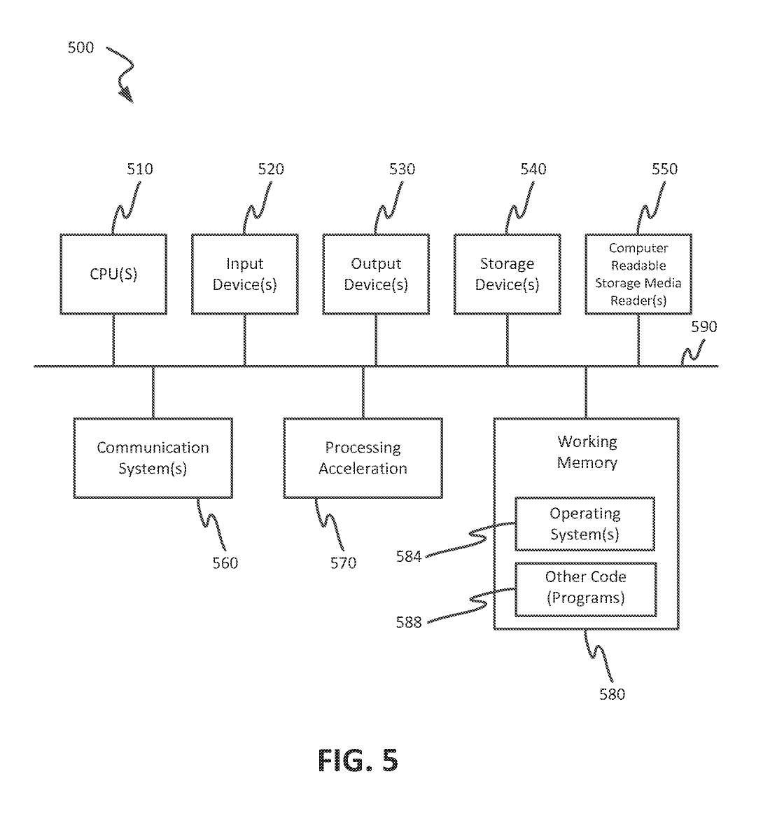

Turning now to FIG. 5, a block diagram is shown illustrating a computer system upon which embodiments of the present invention may be implemented. This example illustrates a computer system 500 such as may be used, in whole, in part, or with various modifications, to provide the functions of the features and/or components of the invention described herein.

The computer system 500 is shown comprising hardware elements that may be electrically coupled via a bus 590. The hardware elements may include one or more central processing units 510, one or more input devices 520 (e.g., a mouse, a keyboard, etc.), and one or more output devices 530 (e.g., a display device, a printer, etc.). The computer system 500 may also include one or more storage device 540. By way of example, storage device(s) 540 may be disk drives, optical storage devices, solid-state storage device such as a random access memory (“RAM”) and/or a read-only memory (“ROM”), which can be programmable, flash-updateable and/or the like.

The computer system 500 may additionally include a computer-readable storage media reader 550, a communications system 560 (e.g., a modem, a network card (wireless or wired), an infra-red communication device, Bluetooth™ device, cellular communication device, etc.), and working memory 580, which may include RAM and ROM devices as described above. In some embodiments, the computer system 500 may also include a processing acceleration unit 570, which can include a digital signal processor, a special-purpose processor and/or the like.

The computer-readable storage media reader 550 can further be connected to a computer-readable storage medium, together (and, optionally, in combination with storage device(s) 540) comprehensively representing remote, local, fixed, and/or removable storage devices plus storage media for temporarily and/or more permanently containing computer-readable information. The communications system 560 may permit data to be exchanged with a network, system, computer and/or other component described above.

The computer system 500 may also comprise software elements, shown as being currently located within a working memory 580, including an operating system 584 and/or other code 588. It should be appreciated that alternate embodiments of a computer system 500 may have numerous variations from that described above. For example, customized hardware might also be used and/or particular elements might be implemented in hardware, software (including portable software, such as applets), or both. Furthermore, connection to other computing devices such as network input/output and data acquisition devices may also occur.

Software of computer system 500 may include code 588 for implementing any or all of the function of the various elements of the architecture as described herein. For example, software, stored on and/or executed by a computer system such as system 500, can provide the functions of any of the print function applet, and/or other components of the invention such as those discussed above.

In the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor or logic circuits programmed with the instructions to perform the methods. These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

While illustrative and presently preferred embodiments of the invention have been described in detail herein, it is to be understood that the inventive concepts may be otherwise variously embodied and employed, and that the appended claims are intended to be construed to include such variations, except as limited by the prior art.

What is claimed is:

1. A method for conducting a money transfer, comprising:
providing, by a computer system, a virtual banking account for conducting the money transfer;
determining, by the computer system, standing instructions corresponding to the virtual banking account, wherein the standing instructions comprise a protocol-based workflow for the computer system to conduct the money transfer;
identifying, by the computer system, a trigger corresponding to a movement of monetary funds from an originating account to the virtual banking account; and
after identifying the trigger, initiating, by the computer system, a transfer of at least a portion of the monetary funds from the virtual banking account to a destination account based on the standing instructions.

2. The method for conducting a money transfer of claim 1, wherein:
the virtual banking account corresponds to the originating account of a sender of the money transfer.

3. The method for conducting a money transfer of claim 1, wherein:
the virtual banking account corresponds to the destination account of a receiver of the money transfer.

4. The method for conducting a money transfer of claim 1, further comprising:
creating, by the computer system, the virtual banking account based on transaction information received at the computer system during a one-time initial set-up.

5. The method for conducting a money transfer of claim 4, further comprising:
creating, by the computer system, the standing instructions based at least in part on the transaction information received at the computer system during the one-time initial set-up;
associating, by the computer system, the standing instructions with the virtual banking account; and
storing, by the computer system, the standing instructions and the virtual banking account.

6. The method for conducting a money transfer of claim 5, further comprising:
determining, by the computer system, the trigger based on at least one of the transaction information and the standing instructions; and
detecting, by the computer system, the trigger corresponding to the virtual banking account.

7. The method for conducting a money transfer of claim 1, wherein:
the trigger comprises a detection of an increase in a balance of the virtual banking account.

8. The method for conducting a money transfer of claim 1, wherein:
the trigger comprises a detection of a movement of the monetary funds from the originating account to the virtual banking account.

9. The method for conducting a money transfer of claim 1, wherein:
the standing instructions comprise an ACH transaction number for the destination account.

10. The method for conducting a money transfer of claim 1, further comprising:
automatically transferring, by the computer system, the monetary funds from the virtual banking account to the destination account upon identifying the trigger.

11. The method for conducting a money transfer of claim 1, wherein:
the protocol-based workflow comprises a schedule for transferring the monetary funds to the destination account, and the schedule indicates the portion of the monetary funds to be transferred to the destination account and a predetermined timeline for transferring the portion to the destination account.

12. The method for conducting a money transfer of claim 1, further comprising:
transferring, by the computer system, a plurality of portions of monetary funds to a plurality of destination accounts.

13. The method for conducting a money transfer of claim 1, further comprising:
notifying, by the computer system, at least one of the originating account and the destination account that the monetary funds are at the virtual banking account.

14. The method for conducting a money transfer of claim 1, further comprising:
requesting, by the computer system, a confirmation from at least one of the originating account and the destination account to transfer the portion of the monetary funds from the virtual banking account to the destination account prior to completing the transfer.

15. The method for conducting a money transfer of claim 14, wherein:
the protocol-based workflow comprises requesting the confirmation upon determining, by the computer system, that the monetary funds exceeds a predetermined threshold amount.

16. The method for conducting a money transfer of claim 1, further comprising:
receiving, by the computer system, a modification to the standing instructions;
modifying, by the computer system, the standing instructions prior to completing the transfer; and
completing, by the computer system, the transfer based on the modified standing instructions.

17. The method for conducting a money transfer of claim 1, further comprising:
adjusting, by the computer system, the portion of the monetary funds based at least in part on a foreign exchange rate; and
transferring, by the computer system, the adjusted portion to the destination account.

18. The method for conducting a money transfer of claim 1, further comprising:
determining, by the computer system, that a holding period of time in which the monetary funds occupy the virtual banking account exceeds a maximum holding period; and
notifying, by the computer system, at least one of the originating account and the destination account that the monetary funds must be transferred out of the virtual banking account based on the determination.

19. A system for conducting a money transfer, comprising:
a computer system, wherein the computer system is configured to:
provide a virtual banking account for conducting the money transfer;
determine standing instructions corresponding to the virtual banking account, wherein the standing instructions comprise a protocol-based workflow for the computer system to conduct the money transfer;
identify a trigger corresponding to a movement of monetary funds from an originating account to the virtual banking account; and
initiating, after identifying the trigger, a transfer of at least a portion of the monetary funds from the virtual banking account to a destination account based on the standing instructions.

20. A computer-readable medium having instructions stored thereon for conducting a money transfer, the instructions executable by one or more processors for at least:
providing a virtual banking account for conducting the money transfer;
determining standing instructions corresponding to the virtual banking account, wherein the standing instructions comprise a protocol-based workflow for the computer system to conduct the money transfer;
identifying a trigger corresponding to a movement of monetary funds from an originating account to the virtual banking account; and
after identifying the trigger, initiating a transfer of at least a portion of the monetary funds from the virtual banking account to a destination account based on the standing instructions.
